(19) United States
(12) Patent Application Publication
(10) Pub. No.: US 2015/0276784 A1
(43) Pub. Date: Oct. 1, 2015

(54) User's Motion Specifying Apparatus

(71) Applicant: CASIO COMPUTER CO., LTD., Shibuya-ku (JP)

(72) Inventor: Kazuaki ABE, Iruma-shi (JP)

(73) Assignee: CASIO COMPUTER CO., LTD., Shibuya-ku (JP)

(21) Appl. No.: 14/659,175

(22) Filed: Mar. 16, 2015

(30) Foreign Application Priority Data
Mar. 31, 2014 (JP) 2014-070976

(51) Int. Cl. G01P 3/02; G01P 15/00

(52) U.S. Cl. CPC G01P 3/02; G01P 15/00

(57) ABSTRACT

A specifying apparatus is provided, which has an acceleration obtaining unit and a face specifying unit. The acceleration obtaining unit obtains information of an acceleration of a tool in a direction of a first axis, wherein the acceleration changes in response to motion of a user using the tool. The face specifying unit specifies a used face of the tool based on the information of an acceleration obtained by the acceleration obtaining unit.

### CROSS-REFERENCE TO RELATED APPLICATION

The present application is based upon and claims the benefit of priority from the prior Japanese Patent Application No. 2014-070976, filed Mar. 31, 2014, the entire contents of which are incorporated herein by reference.

### BACKGROUND OF THE INVENTION

1. Field of the Invention

The present invention relates to a specifying apparatus, a specifying method, and a program for specifying motion of a user.

2. Description of the Related Art

Japanese Unexamined Patent Publication No. 2009-125499 discloses a technology, in which various sorts of sensors are fixed on a racket, and orbits and a variation in angle of the racket are detected by the sensors when a user swings the racket, whereby the user's motion of swinging the racket is specified.

### SUMMARY OF THE INVENTION

According to one aspect of the invention, there is provided a specifying apparatus which comprises an acceleration obtaining unit which obtains information of an acceleration of a tool in a direction of a first axis, wherein the acceleration changes in response to motion of a user using the tool, and a face specifying unit which specifies a used face of the tool based on the information of an acceleration obtained by the acceleration obtaining unit.

According to another aspect of the invention, there is provided a specifying apparatus which comprises an acceleration obtaining unit which obtains information of an acceleration in a direction of a first axis, wherein the acceleration changes in response to motion of a user, an angular velocity obtaining unit which obtains information of a first angular velocity about the first axis, wherein the angular velocity changes in response to the motion of the user, and a motion specifying unit which specifies the motion of the user based on the information of an acceleration obtained by the acceleration obtaining unit and the information of a first angular velocity obtained by the angular velocity obtaining unit.

According to other aspect of the invention, there is provided a specifying apparatus which comprises an acceleration obtaining unit which obtains information of an acceleration in a direction of a first axis, wherein the acceleration changes in response to motion of a user, an angular velocity obtaining unit which obtains information of a second angular velocity about a second axis, which is different from the first axis, wherein the second angular velocity changes in response to the motion of the user, and a motion specifying unit which specifies the motion of the user based on the information of an acceleration obtained by the acceleration obtaining unit and the information of a second angular velocity obtained by the angular velocity obtaining unit.

According to still another aspect of the invention, there is provided a specifying method in a specifying apparatus, which method comprises a step of obtaining information of an acceleration of a tool in a direction of a first axis, wherein the acceleration changes in response to motion of a user using the tool, and a step of specifying a used face of the tool based on the obtained information of an acceleration.

According to yet another aspect of the invention, there is provided a non-transitory computer-readable storage medium with an executable program stored thereon, wherein the program instructs a computer to function as: an acceleration obtaining unit for obtaining information of an acceleration of a tool in a direction of a first axis, wherein the acceleration changes in response to motion of a user using the tool; and a face specifying unit for specifying a used face of the tool based on the information of an acceleration obtained by the acceleration obtaining unit.

### BRIEF DESCRIPTION OF THE DRAWINGS

FIG. 1 is a block diagram showing a configuration of a specifying apparatus according to the embodiment of the present invention.

FIG. 2 is a view schematically showing a tennis racket with the specifying apparatus attached to.

FIG. 3 is a view showing an example of a motion specifying table “T” stored in the specifying apparatus shown in FIG. 1.

FIG. 4 is a flow chart showing an example of an operation of a motion specifying process performed in the specifying apparatus shown in FIG. 1.

FIG. 5A and FIG. 5B are views schematically showing outputs from an acceleration sensor and an angular velocity sensor provided in the specifying apparatus shown in FIG. 1.

FIG. 6A and FIG. 6B are views schematically showing outputs from an acceleration sensor and an angular velocity sensor provided in the specifying apparatus shown in FIG. 1.

### DETAILED DESCRIPTION OF THE PREFERRED EMBODIMENTS

Now, preferred embodiments of the invention will be described with reference to the accompanying drawings in detail. It will be understood that the scope of the invention is not restricted to the specific embodiments described herein.

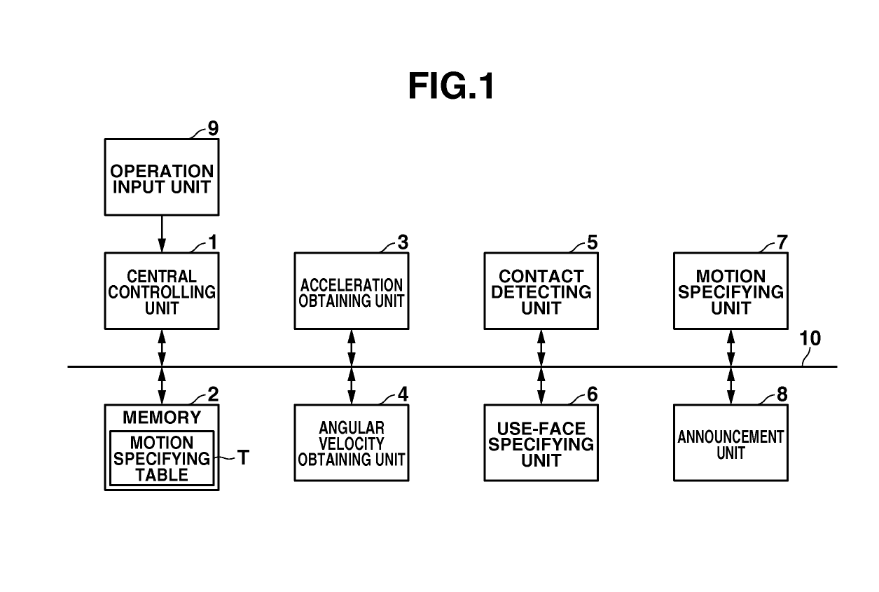

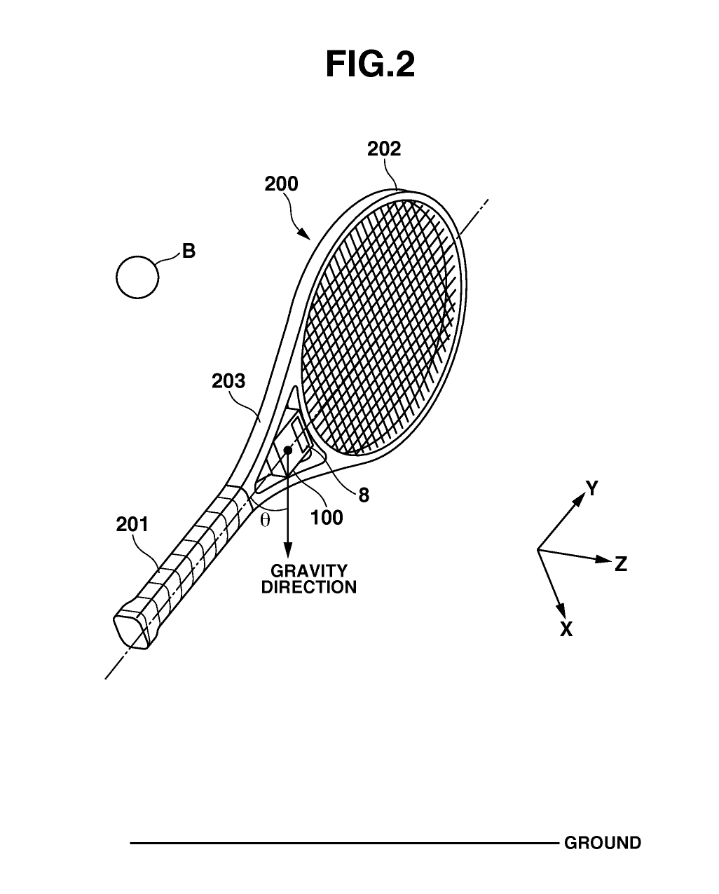

FIG. 1 is a block diagram showing a configuration of a specifying apparatus 100 according to the embodiment of the invention. FIG. 2 is a view schematically showing a tennis racket 200 with the specifying apparatus 100 attached to.

In the following description, it is assumed that an X-axis is set in the direction which intersects approximately at right angles with the direction along which the grip portion 201 of the tennis racket 200 extends, a Y-axis is set in the direction which intersects approximately at right angles with the direction of the X-axis and also in the direction along which the grip portion 201 of the tennis racket 200 extends, and a Z-axis is set in the direction which intersects approximately at right angles with the direction of the X-axis and the direction of the Y-axis, that is, in the direction which intersects approximately at right angles with the racket face of the tennis racket 200, wherein the racket face is used to hit a tennis ball “B”.

As shown in FIG. 1, the specifying apparatus 100 according to the embodiment of the invention comprises a central controlling unit 1, a memory 2, an acceleration obtaining unit 3, an angular velocity obtaining unit 4, a contact detecting unit 5, a use-face specifying unit 6, a motion specifying unit 7, an announcement unit 8, and an operation input unit 9.

The central controlling unit 1, the memory 2, the acceleration obtaining unit 3, the angular velocity obtaining unit 4, the contact detecting unit 5, the use-face specifying unit 6, the motion specifying unit 7, and the announcement unit 8 are connected to each other through a bus line 10.

As shown in FIG. 2, the apparatus body of the specifying apparatus 100 is detachably mounted, for instance, on the tennis racket (tool) 200 used to hit the tennis ball (object) “B”. More specifically, the apparatus body of the specifying apparatus 100 is fixed to an inside of a shaft portion 203 prepared between the grip portion 201 of the tennis racket 200 to be held by a user and the frame 202 (forming the racket face) of the tennis racket 200.

The apparatus body of the specifying apparatus 100 is fixed to the inside of the shaft portion 203 such that the center of the apparatus body is put on an imaginary axis extending along the direction of the Y-axis in which the grip portion 201 of the tennis racket 200 extends. It is possible to fix the apparatus body of the specifying apparatus 100, for example, directly to the shaft portion 203, or to fix the apparatus body to the shaft portion 203 by means of a fixing tool (not shown).

Further, the position where the apparatus body of the specifying apparatus 100 is to be fixed is not restricted to the position described above, but it is possible to fix the apparatus body to any position on the tennis racket 200. For instance, the apparatus body of the specifying apparatus 100 can be fixed to the end of the grip portion 201 of the tennis racket 200 opposite to the frame 202 of the tennis racket 200.

The central controlling unit 1 serves to control the whole operations of the units composing the specifying apparatus 100. More specifically, the central controlling unit 1 comprises CPU (Central Processing Unit), RAM (Random Access Memory), and ROM (Read Only Memory) (these are not shown), and performs various controlling operations in accordance with process programs (not shown) for the specifying apparatus 100 stored in ROM. While the controlling operations are being performed, CPU stores various processed results in a storing area of RAM and displays the processed results on the announcement unit 8 as needed.

RAM has a program storing area where the process program is expanded to be executed by CPU and a data storing area where input data and processed results generated during performance of the process program are stored.

ROM stores a program written in computer readable program codes such as a system program executable by the specifying apparatus 100, the various sorts of process programs operated on the system program, and data used during operation of the process program.

The memory 2 consists, for instance, of DRAM (Dynamic Random Access Memory) and temporarily stores data processed by the central controlling unit 1, the acceleration obtaining unit 3, the angular velocity obtaining unit 4, the contact detecting unit 5, the use-face specifying unit 6, the motion specifying unit 7, and the announcement unit 8.

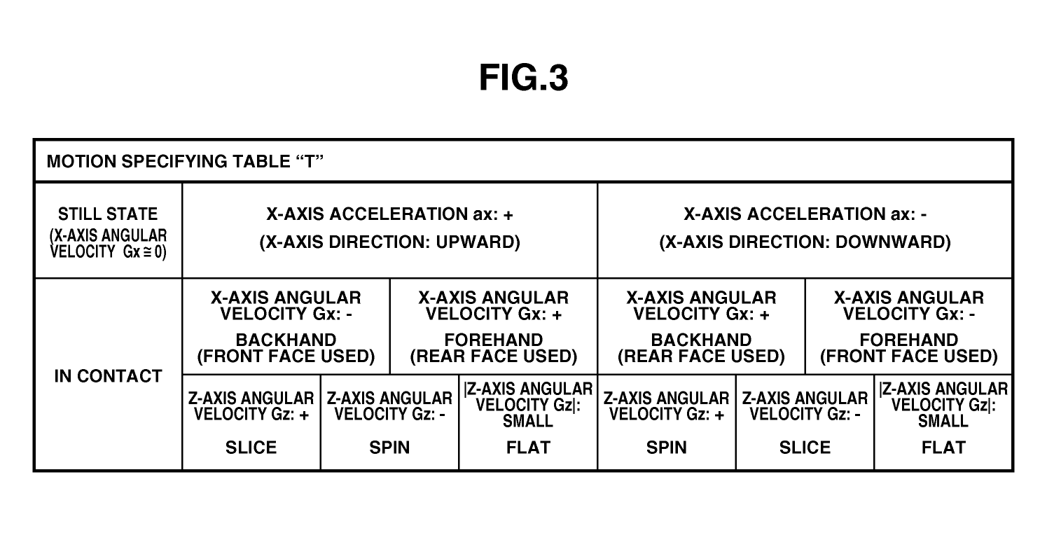

The memory 2 has a motion specifying table “T” (refer to FIG. 3) which is used in a motion specifying process.

The motion specifying table “T” is used to specify a racket face to be used by the user to hit the tennis ball “B”, and is used to determine whether the user hits the ball “B” forehand or backhand, and is also used to determine whether a slice, spin or flat is given on the tennis ball “B” by the user.

In the motion specifying table “T”, the signs of X-axis accelerations “ax” obtained by the acceleration obtaining unit 3 are defined, while the tennis racket 200 is kept in still state (an X-axis angular velocity Gx≈0), and further, the signs of X-axis angular velocities “Gx” and the signs and the absolute values of Z-axis angular velocities “Gz” obtained by the acceleration obtaining unit 3 are defined at a time when the tennis ball “B” has come in contact with the tennis racket 200.

For instance, as shown in the motion specifying table “T” of FIG. 3, when the sign of the X-axis acceleration “ax” is “positive” (“+”) during the tennis racket 200 is kept instill state, a case (1) of the “negative” sign of the X-axis angular velocity “Gx” and “backhand” (the front face is used), and a case (2) of the “positive” sign of the X-axis angular velocity “Gx” and “forehand” (the rear face is used) are assigned at the time when the tennis ball “B” has come in contact with the tennis racket 200. Further, a case (3) of the “positive” sign of the Z-axis angular velocity “Gz” and a “slice” given on the tennis ball “B”, a case (4) of the “negative” sign of the Z-axis angular velocity “Gz” and a “spine” given on the tennis ball “B”, and a case (5) where the absolute value of the Z-axis angular velocity “Gz” is smaller than a prescribed value and a “flat” is given on the tennis ball “B” are assigned at the time when the tennis ball “B” has come in contact with the tennis racket 200.

Further, in the motion specifying table “T”, when the sign of the X-axis acceleration “ax” is “negative” (“−”) during the tennis racket 200 is kept in still state, a case (6) of the “positive” sign of the X-axis angular velocity “Gx” and “backhand” (the rear face is used), and a case (7) of the “negative” sign of the X-axis angular velocity “Gx” and “forehand” (the front face is used) are assigned at the time when the tennis ball “B” has come in contact with the tennis racket 200. Further, a case (8) of the “positive” sign of the Z-axis angular velocity “Gz” and a “spin” given on the tennis ball “B”, a case (9) of the “negative” sign of the Z-axis angular velocity “Gz” and a “slice” given on the tennis ball “B”, and a case (10) where the absolute value of the Z-axis angular velocity “Gz” is smaller than the prescribed value and a “flat” is given on the tennis ball “B” are assigned at the time when the tennis ball “B” has come in contact with the tennis racket 200.

The motions of the user (forehand swing, backhand swing) and the states (slice, spine, flat) of the tennis ball “B” defined in the motion specifying table “T” are examples and are not restricted to those given in the table “T” and can be changed. Relative relationships among the states of the tennis ball “B”, the signs and the absolute values of the Z-axis angular velocity “Gz” are well known and disclosed in Japanese Unexamined Patent Publication No. 2009-125499. Therefore, the relative relationships will not be described herein in detail.

The acceleration obtaining unit 3 obtains information of accelerations of the apparatus body of the specifying apparatus 100 in prescribed axial directions. In other words, the acceleration obtaining unit 3 obtains the information of an acceleration of the tennis racket 200 in the direction of the X-axis (first axis), wherein the tennis racket 200 moves in accordance with the user's swinging motion.

More specifically, the acceleration obtaining unit 3 has a tri-axial acceleration sensor (not shown) for detecting accelerations of the apparatus body of the specifying apparatus 100 generated respectively in the three directions of the axes orthogonal to each other. Using the tri-axial acceleration sensor, the acceleration obtaining unit 3 obtains accelerations “ax”, “ay”, and “az” in the directions of the X-, Y-, and Z-axes, respectively. The accelerations “ax”, “ay”, and “az” obtained by the acceleration obtaining unit 3 can be temporarily stored in a prescribed storing unit (for instance, in the memory 2).

The angular velocity obtaining unit 4 serves to detect angular velocities of the apparatus body of the specifying apparatus 100 which rotates about prescribed axes. In other words, when the body of the specifying apparatus 100 moves in response to the user's motion, the angular velocity obtaining unit 4 obtains information of a first angular velocity of a rotation of the apparatus body about the X-axis (first axis) and information of a second angular velocity of a rotation of the apparatus body about the Z-axis (second axis).

More specifically, the angular velocity obtaining unit 4 has a tri-axial angular velocity sensor (not shown) for detecting angular velocities of the apparatus body of the specifying apparatus 100 about the three axes orthogonal to each other, respectively. Using the tri-axial angular velocity sensor, the angular velocity obtaining unit 4 obtains angular velocities of the apparatus body of the specifying apparatus 100 about the X-, Y-, and Z-axes, respectively. The angular velocities “Gx”, “Gy”, and “Gz” obtained by the angular velocity obtaining unit 4 can be temporarily stored in a prescribed storing unit (for instance, in the memory 2).

The contact detecting unit 5 serves to detect that the tennis racket (tool) 200 has contacted with the tennis ball “B”. More specifically, the contact detecting unit 5 detects that the tennis racket (tool) 200 has contacted with the tennis ball “B”, for instance, based on an X-axis angular velocity “Gx” of the apparatus body of the specifying apparatus 100 rotating about the X-axis detected by the angular velocity obtaining unit 4.

In other words, when the user hits the tennis ball “B” with the tennis racket 200, to which the apparatus body of the specifying apparatus 100 is fixed, an X-axis angular velocity “Gx” will be less than a prescribed threshold value at the time just before the tennis ball “B” has come in contact with the racket face, and will exceed the prescribed threshold value just after the tennis ball “B” has come in contact with the racket face. On the basis of the prescribed threshold value, the contact detecting unit 5 detects a timing when the tennis ball “B” has come in contact with the racket face, based on the X-axis angular velocity “Gx”. And the contact detecting unit 5 outputs timing information indicating the detected timing to the motion specifying unit 7.

It is also possible to provide a separate sensor specialized in detecting the X-axis angular velocity “Gx” on the contact detecting unit 5. The method of detecting that the tennis ball “B” has come in contact with the racket face is described by way of example, and therefore, such method is not limited to the above. For instance, it is possible to detect that the tennis ball “B” has come in contact with the racket face, based on an acceleration in a prescribed direction detected by the acceleration sensor and also based on an electric configuration and/or a pressure sensor.

The use-face specifying unit 6 serves to specify the racket face of the tennis racket 200 to be used to hit the tennis ball “B”.

In other words, before hitting the tennis ball “B”, the use-face specifying unit 6 specifies the racket face of the tennis racket 200 to hit the tennis ball “B”, based on the X-axis acceleration previously obtained by the acceleration obtaining unit 3.

More specifically, for example, when the user is ready with the tennis racket 200 for hitting the ball, the top end portion of the tennis racket 200 will be maintained at a little up side. And when the user takes a pose such that the direction in which the grip portion 201 of the tennis racket 200 extends will incline by an angle of “θ” to the vertical direction to the ground with the direction of the X-axis indicating the ground, an X-axis acceleration “ax” to be detected by the acceleration sensor will be given by the following equation:

ax=−G(gravitational acceleration)·sin θ

Since the sign of sin θ does not change with the direction of the X-axis indicating the ground, that is, within the range of 0 deg.<θ<180 deg., the use-face specifying unit 6 can specify based on the sign of the X-axis acceleration “ax”, whether the front or rear face of the tennis racket 200 is used to hit the tennis ball “B”, when the user hits the tennis ball “B” forehand or backhand.

For example, when the sign of the X-axis acceleration “ax” obtained by the acceleration obtaining unit 3 is “negative”, the use-face specifying unit 6 refers to the motion specifying table “T” to determine that the front face of the tennis racket 200 is used to hit the tennis ball “B”, when the user hits the ball “B” “backhand”, and to determine that the rear face of the tennis racket 200 is used to hit the tennis ball “B”, when the user hits the ball “B” “forehand”. Meanwhile, when the sign of the X-axis acceleration “ax” is “positive”, the use-face specifying unit 6 determines that the rear face of the tennis racket 200 is used to hit the tennis ball “B”, when the user hits the ball “B” “backhand”, and determines that the front face of the tennis racket is used to hit the tennis ball “B”, when the user hits the ball “B” “forehand”.

The use-face specifying unit 6 also can determine whether the user has hit the ball “forehand” or “backhand”, depending on the sign of the X-axis angular velocity “Gx” detected by the angular velocity sensor at the time when the tennis racket 200 has come in contact with the tennis ball “B”. The detail of the above determination by the use-face specifying unit 6 will be described later.

The use-face specifying unit 6 performs a process for judging whether an angular velocity (for instance, X-axis angular velocity “Gx”) of the apparatus body of the specifying apparatus 100 rotating about a prescribed axis detected by the angular velocity obtaining unit 4 keeps approximately “0” for a prescribed time. When the use-face specifying unit 6 determines that the angular velocity keeps “0”, it is possible to determine that the tennis racket 200 is kept in still state, and the racket face to be used to hit the tennis ball “B” can be specified based on the sign of the X-axis acceleration “ax”.

Since some user will rotate the tennis racket 200 about the axis extending along the grip shaft 201 just before hitting the tennis ball “B”, it is preferable for the use-face specifying unit 6 to judge whether the angular velocity of the apparatus body of the specifying apparatus 100 rotating about a prescribed axis keeps approximately “0”, just before the timing when the contact detecting unit 5 detects that the tennis racket 200 has come in contact with the tennis ball “B”.

The motion specifying unit 7 serves to specify a motion of the user who uses the tennis racket 200.

In other words, the motion specifying unit 7 specifies the motion of the user, such as motions of swinging the tennis racket 200 and ways of hitting the tennis ball “B”, depending on the used face of the tennis racket 200 specified by the use-face specifying unit 6 and the X-axis angular velocity (information of the first angular velocity) “Gx” obtained by the angular velocity obtaining unit 4. More specifically, the motion specifying unit 7 specifies a state of the tennis ball (object) B hit by the user using the tennis racket 200, depending on the used face of the tennis racket 200 specified by the use-face specifying unit 6 and the X-axis angular velocity “Gx” and Z-axis angular velocity “Gz” (information of the first and the second angular velocities) obtained by the angular velocity obtaining unit 4.

For example, receiving from the contact detecting unit 5 the timing information representing the timing when the tennis racket 200 has come in contact with the tennis ball “B”, the motion specifying unit 7 obtains information representing the used face of the tennis racket 200 from the use-face specifying unit 6 and the X-axis angular velocity “Gx” and Z-axis angular velocity “Gz” (information of the first and the second angular velocities) from the angular velocity obtaining unit 4. Then, the motion specifying unit 7 refers to the motion specifying table “T” to judge whether the user hits the tennis ball “B” “forehand” or “backhand” and also to judge whether the user has given a “slice”, “spin” or “flat” on the tennis ball “B”.

More specifically, in the case where the tennis racket 200 is kept in still state and the sign of the X-axis acceleration “ax” is “positive”, the motion specifying unit 7 determines that the user hits the ball “backhand” (the front face is used), when the sign of the X-axis angular velocity “Gx” is “negative” at the time when the tennis racket 200 is in contact with the tennis ball “B”, and determines that the user hits the ball “forehand” (the rear face is used), when the sign of the X-axis angular velocity “Gx” is “positive” at the time when the tennis racket 200 is in contact with the tennis ball “B”. Further, the motion specifying unit 7 determines that the user hits the ball to give a “slice”, when the sign of the Z-axis angular velocity “Gz” obtained by the angular velocity obtaining unit 4 is “positive”, when the tennis racket 200 is in contact with the tennis ball “B”, and determines that the user hits the ball to give a “spin”, when the sign of the Z-axis angular velocity “Gz” obtained by the angular velocity obtaining unit 4 is “negative”, when the tennis racket 200 is in contact with the tennis ball “B”, and determines that the user hits the ball to give a “flat”, when the absolute value of the Z-axis angular velocity “Gz” is smaller than a prescribed value.

Meanwhile, in the case where the tennis racket 200 is kept in still state and the sign of the X-axis acceleration “ax” is “negative”, the motion specifying unit 7 determines that the user hits the ball “backhand” (the rear face is used), when the sign of the X-axis angular velocity “Gx” is “positive” at the time when the tennis racket 200 is in contact with the tennis ball “B”, and determines that the user hits the ball “forehand” (the front face is used), when the sign of the X-axis angular velocity “Gx” is “negative” at the time when the tennis racket 200 is in contact with the tennis ball “B”. Further, the motion specifying unit 7 determines that the user hits the ball to give a “spin”, when the sign of the Z-axis angular velocity “Gz” obtained by the angular velocity obtaining unit 4 is “positive”, when the tennis racket 200 is in contact with the tennis ball “B”, and determines that the user hits the ball to give a “slice”, when the sign of the Z-axis angular velocity “Gz” obtained by the angular velocity obtaining unit 4 is “negative”, when the tennis racket 200 is in contact with the tennis ball “B”, and determines that the user hits the ball to give a “flat”, when the absolute value of the Z-axis angular velocity “Gz” is smaller than a prescribed value.

The announcement unit 8 consists of light-emitting diodes and/or a so-called a liquid crystal display panel of a seven-segment type, and announces various sorts of information. More specifically, the announcement unit 8 announces the used face of the tennis racket 200 specified by the use-face specifying unit 6 and the user's motion (including the states of the tennis ball “B”—“slice”, “spin”, and “flat”).

The operation input unit 9 consists of data-input keys for inputting numerals and characters, cursor keys for selecting and/or sending data, and/or function keys. When operated by the user, the operation input unit 9 sends CPU of the central controlling unit 1 a signal corresponding to the key operated by the user.

It is possible to provide a touch panel as the operation input unit 9 on the display image of the announcement unit 8, allowing the user to touch the touch panel to input an instruction corresponding to touched position.

### <Motion Specifying Process>

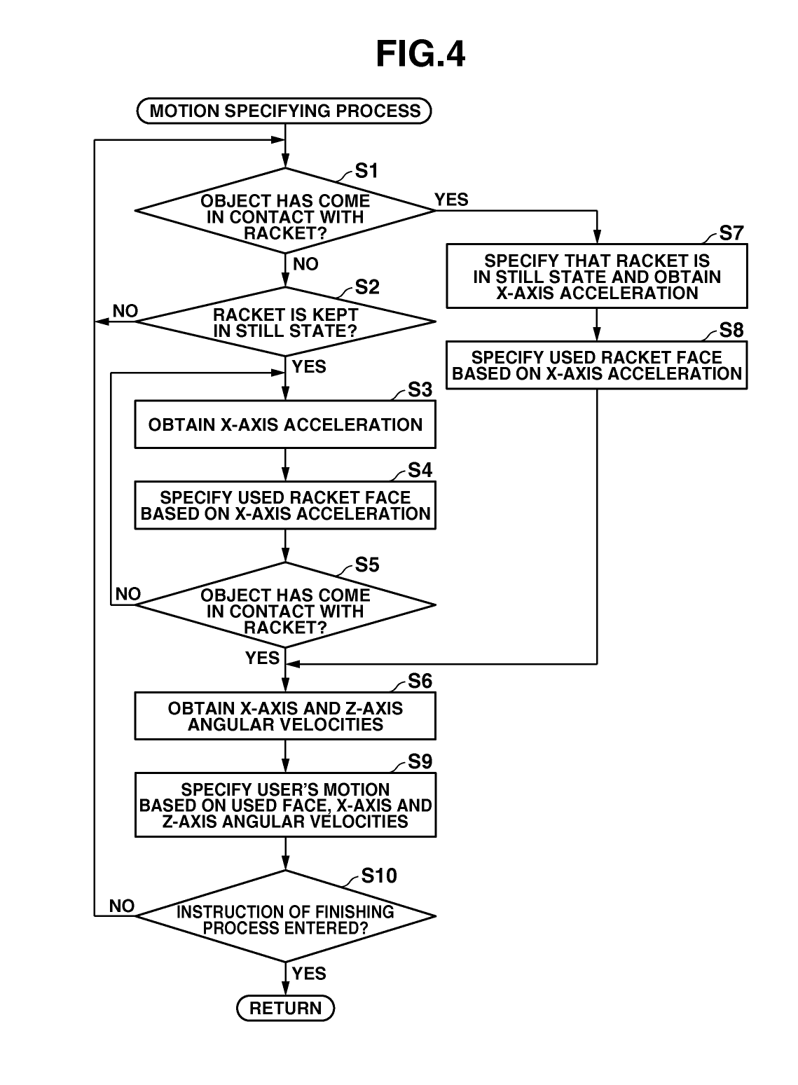

A motion specifying process performed in the specifying apparatus 100 will be described with reference to a flow chart shown in FIG. 4. FIG. 4 is a flow chart showing an example of an operation of the motion specifying process performed in the specifying apparatus 100 shown in FIG. 1. It is premised that the apparatus body of the specifying apparatus 100 is mounted on the shaft portion 203 of the tennis racket 200.

The contact detecting unit 5 judges based on the X-axis angular velocity “Gx” obtained by the angular velocity obtaining unit 4, whether the tennis ball (object) “B” has come in contact with the tennis racket 200 (step S1 in FIG. 4).

When it is determined that the tennis ball “B” has not come in contact with the tennis racket 200 (NO at step S1), the use-face specifying unit 6 judges whether the tennis racket 200 is kept in still state (step S2). More specifically, the use-face specifying unit 6 judges whether the X-axis angular velocity “Gx” of the apparatus body of the specifying apparatus 100 obtained by the angular velocity obtaining unit 4 keeps approximately “0” for a prescribed time, thereby judging whether the tennis racket 200 is kept in still state.

When it is determined that the tennis racket 200 is not kept in still state (NO at step S2), CPU of the central controlling unit 1 returns to step S1, performing the subsequent processes.

Meanwhile, when it is determined that the tennis racket 200 is kept in still state (YES at step S2), the acceleration obtaining unit 3 (tri-axial acceleration sensor) obtains an X-axis acceleration “ax” of the apparatus body of the specifying apparatus 100 (step S3).

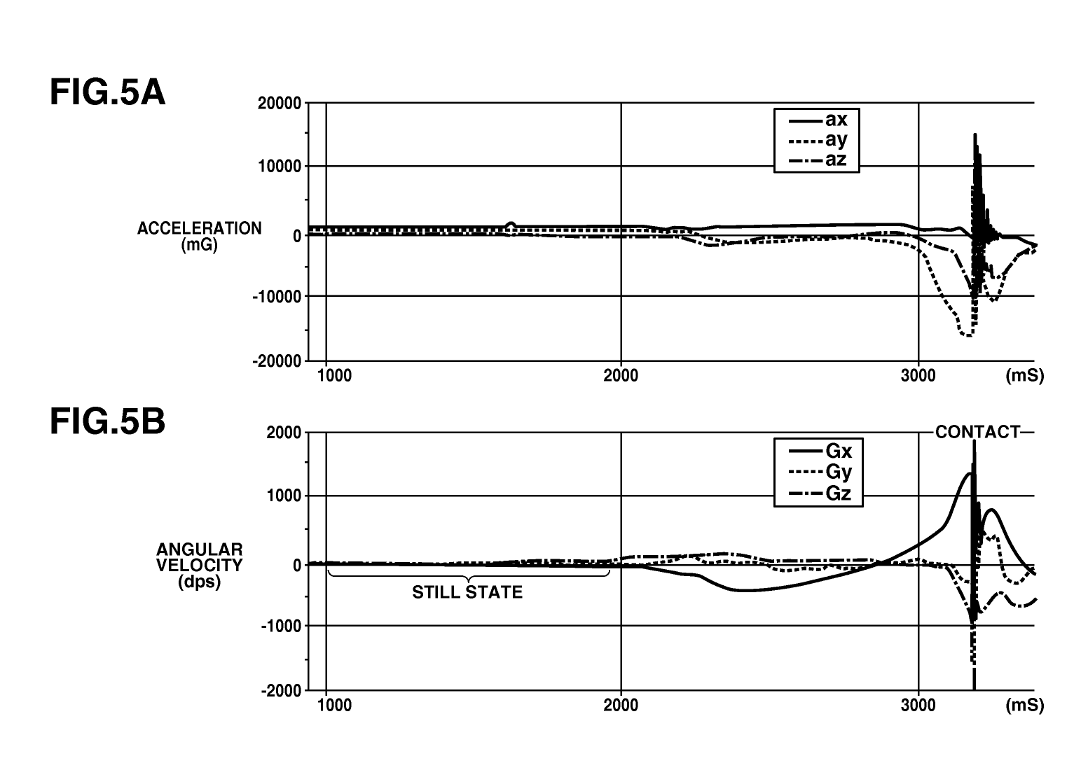

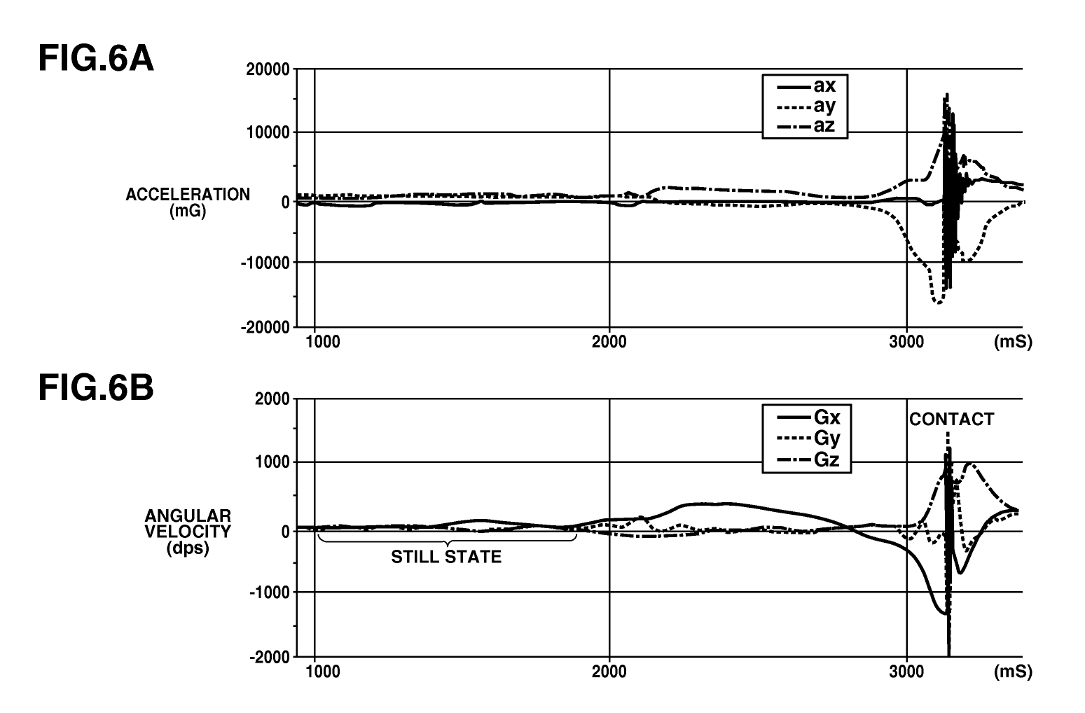

For example, as shown in FIG. 5B and FIG. 6B, the X-axis angular velocity “Gx” of the apparatus body of the specifying apparatus 100 keeps approximately “0” during a period of 1000 to 2000 [mS]. In this case, the use-face specifying unit 6 determines that the tennis racket 200 is kept in still state and the acceleration obtaining unit 3 obtains the X-axis acceleration “ax” of the apparatus body of the specifying apparatus 100 during the same period of 1000 to 2000 [mS] shown in FIG. 5A.

Then, the use-face specifying unit 6 refers to the motion specifying table “T” to specify the racket face of the tennis racket 200 to be used to hit the tennis ball “B” based on the X-axis acceleration “ax” obtained by the acceleration obtaining unit 3 (step S4).

For example, since the sign of the X-axis acceleration “ax” is “positive” during the period of 1000 to 2000 [mS], in which the tennis racket 200 is kept in still state, as shown in FIG. 5A, the use-face specifying unit 6 determines that the user uses the “front” face of the tennis racket 200 to hit the tennis ball “B” “backhand”, and determines that the user uses the “rear” face of the tennis racket 200 to hit the ball “B” “forehand”. Further, since the sign of the X-axis acceleration “ax” is “negative” during the period of 1000 to 2000 [mS], in which the tennis racket 200 is kept in still state, as shown in FIG. 6A, the use-face specifying unit 6 determines that the user uses the “rear” face of the tennis racket 200 to hit the tennis ball “B” “backhand”, and determines that the user uses the “front” face of the tennis racket 200 to hit the tennis ball “B” “forehand”.

Again, the contact detecting unit 5 judges based on the X-axis angular velocity “Gx” obtained by the angular velocity obtaining unit 4, whether the tennis ball “B” has come in contact with the tennis racket 200 (step S5).

When it is determined that the tennis ball “B” has not come in contact with the tennis racket 200 (NO at step S5), CPU of the central controlling unit 1 returns to step S3, performing the subsequent processes.

When it is determined that the tennis ball “B” has come in contact with the tennis racket 200 (YES at step S5), the angular velocity obtaining unit (tri-axial angular velocity sensor) 4 obtains the X-axis angular velocity “Gx” of the apparatus body of the specifying apparatus 100 about the X-axis and the Z-axis angular velocity “Gz” of the apparatus body of the specifying apparatus 100 about the Z-axis (step S6).

Meanwhile, when it is determined that the tennis ball “B” has come in contact with the tennis racket 200 (YES at step S1), the use-face specifying unit 6 determines that the angular velocity keeps approximately “0” and the tennis racket 200 is kept in still state, and the acceleration obtaining unit 3 obtains the X-axis acceleration “ax” of the apparatus body of the specifying apparatus 100, at the time when the tennis racket 200 is kept in still state (step S7), before the contact detecting unit 5 will detect that the tennis racket 200 contacts with the tennis ball “B”, based on the X-axis angular velocity “Gx” of the apparatus body of the specifying apparatus 100 temporarily stored in the prescribed memory (for instance, in the memory 2).

Subsequently, the use-face specifying unit 6 performs a process similar to that at step S4, referring to the motion specifying table “T” to specify the racket face of the tennis racket 200 used by the user to hit the tennis ball “B” based on the X-axis acceleration “ax” obtained by the acceleration obtaining unit 3 (step S8).

Thereafter, CPU of the central controlling unit 1 advances to step S6, where the angular velocity obtaining unit 4 obtains the X-axis angular velocity “Gx” and the Z-axis angular velocity “Gz” of the apparatus body of the specifying apparatus 100 (step S6).

Further, based on the used face of the tennis racket 200 specified by the use-face specifying unit 6 and the X-axis angular velocity “Gx” and the Z-axis angular velocity “Gz” obtained by the angular velocity obtaining unit 4, the motion specifying unit 7 specifies a way of swinging the tennis racket 200 and a way of hitting the tennis ball “B” (step S9).

For example, since the sign of the angular velocity “Gx” is “positive” while the tennis racket 200 is in contact with the tennis ball (object) “B”, as shown in FIG. 5B, the motion specifying unit 7 determines that the user hits the tennis ball “B” “forehand” (the rear face is used). Further, since the sign of the Z-axis angular velocity “Gz” is “positive”, the motion specifying unit 7 determines that the way of hitting the tennis ball “B” is to give a “slice”.

Further, since the sign of the angular velocity “Gx” is “negative” while the tennis racket 200 is in contact with the tennis ball (object) “B”, as shown in FIG. 6B, the motion specifying unit 7 determines that the user hits the tennis ball “B” “forehand” (the front face is used). Since the sign of the Z-axis angular velocity “Gz” is “positive”, the motion specifying unit 7 determines that the way of hitting the tennis ball “B” is to give a “slice”.

Then, CPU of the central controlling unit 1 judges whether the user has operated the operation input unit 9 to input an instruction of finishing the motion specifying process (step S10).

When it is determined that the instruction of finishing the motion specifying process has not been input (NO at step S10), CPU of the central controlling unit 1 returns to step S1, performing the subsequent processes.

Meanwhile, when it is determined that the instruction of finishing the motion specifying process has been input (YES at step S10), CPU of the central controlling unit 1 finishes the motion specifying process.

As described above, in the specifying apparatus 100 according to the embodiment of the invention, the racket face of the tennis racket 200 to be used to hit the tennis ball “B” is specified based on the information of the X-axis acceleration varying in response to the user's motion. Therefore, there is no need to previously determine which face of the tennis racket 200 is to be used to hit the tennis ball “B” when the user's motion is specified, but also the tennis racket face to be used to hit the tennis ball “B” can be properly specified before the racket face has come in contact with the tennis ball “B”, even though the tennis racket face to be used changes in accordance with user's motion, and the user's motion can be specified based on the specified tennis racket face more precisely.

More specifically, since the user's motion is specified based on the racket face of the tennis racket 200 specified to be used to hit the ball “B” and the X-axis angular velocity “Gx” obtained when the tennis racket 200 has come in contact with the tennis ball “B”, it is possible to specify more precisely, whether the user hits the tennis ball “B” “forehand” (the front face is used) or “backhand” (the rear face is used). Further, since the state of the tennis ball “B” hit with the tennis racket 200 is specified based on the racket face of the tennis racket 200 and the X-axis angular velocity “Gx” and the Z-axis angular velocity of the body of the specifying apparatus 100 obtained when the tennis racket 200 has come in contact with the tennis ball “B”, it is possible to specify more precisely whether the way of hitting the tennis ball “B” is to give a “slice”, “spin”, or “flat”.

It is possible to reasonably obtain the X-axis acceleration “ax” and the X-axis angular velocity “Gx” measured in parallel with the racket face of the tennis racket 200 and about the X-axis intersecting, approximately at right angles, the direction in which the grip portion 201 of the tennis racket 200 extends. Further, it is possible to properly obtain the Z-axis angular velocity “Gz” about the Z-axis intersecting the racket face of the tennis racket 200 at right angles. The specifying apparatus 100 is fixed on the imaginary axis extending from the grip portion 201 of the tens racket 200, and therefore the X-axis acceleration “ax” and the Z-axis angular velocity “Gz” can be obtained more precisely, and also the racket face of the tennis racket 200 to be used to hit the tennis ball “B” and the motion of the user can be specified more properly.

It will be understood that the invention is not limited to the particular embodiments described herein, but modifications and rearrangements may be made to the disclosed embodiments while remaining within the spirit of the invention.

In the specifying apparatus 100 according to the embodiment of the invention, the racket face of the tennis racket 200 to be used to hit the tennis ball “B” is previously specified, but it is not always necessary to specify the racket face for hitting the tennis ball “B” before hand. In other words, it is possible to modify the motion specifying unit 7 so as to determine based on the information of X-axis acceleration “ax” and the X-axis angular velocity “Gx” obtained when the tennis racket 200 has come in contact with the tennis ball “B” that the user hits the tennis ball “B” “forehand” (the front racket face is used) or “backhand” (the rear racket face is used). Further, it is possible to modify the motion specifying unit so as to determine based on the information of X-axis acceleration “ax” and the X-axis angular velocity “Gx” and the Z-axis angular velocity “Gz” obtained when the tennis racket 200 has come in contact with the tennis ball “B” that the user's way of hitting the tennis ball “B” is to give a “slice”, “spin” or “flat”.

The motion specifying unit 7 can be modified so as to determine based on the information of X-axis acceleration “ax” and the Z-axis angular velocity “Gz” obtained when the tennis racket 200 has come in contact with the tennis ball “B” that the user's way of hitting the tennis ball “B” is to give a “slice”, “spin” or “flat”. Further, the motion specifying unit 7 can be modified so as to determine based on the information of X-axis acceleration “ax” and the X-axis angular velocity “Gx” and the Z-axis angular velocity “Gz” obtained when the tennis racket 200 has come in contact with the tennis ball “B” that the user hits the tennis ball “B” “forehand” (the front racket face is used) or “backhand” (the rear racket face is used).

In the embodiment of the invention, the specifying apparatus 100 is fixed on the tennis racket 200, but the specifying apparatus 100 is not always necessary to be fixed on the tennis racket 200. The tennis racket 200 is provided with the acceleration sensor and the angular velocity sensor, and therefore the specifying apparatus 100 can be modified so as to obtain the accelerations detected by the acceleration sensor and the angular velocities detected by the angular velocity sensor through wireless communication to specify the racket face of the tennis racket 200 to be used to hit the tennis ball “B” and the user's motion.

In the embodiment of the invention, the tennis racket 200 has been described as an example of the tool, and therefore, other tool having a face to be used to hit the object can be used in place of the tennis racket 200. When the other tool is used, it is preferable to mount the present specifying apparatus 100 on an axis extending from a holding portion of the other tool to be held by the user.

In the above embodiment of the invention, only an example of the configuration of the specifying apparatus 100 has been described and other configuration will be employed for the specifying apparatus 100.

In addition, in the specifying apparatus 100 according to the embodiment of the invention, the function of obtaining accelerations and the function of specifying racket face are realized by the acceleration obtaining unit 3 and the use-face specifying unit 6 under control of the central controlling unit 1, respectively, but will be realized by CPU of the central controlling unit 1 which runs a prescribed program.

In other words, a program including a routine of an acceleration obtaining process and a routine of a racket face specifying process is stored in a program memory (not shown). CPU of the central controlling unit 1 runs the routine of an acceleration obtaining process to function as a unit of obtaining information of an acceleration in the direction of a first axis, which acceleration changes in response to the motion of the user having the tool. Further, CPU of the central controlling unit 1 runs the routine of a racket face specifying process to function as a unit of specifying the tool's face to be used, based on the obtained information of an acceleration.

Similarly, the specifying apparatus 100 can be modified such that CPU of the central controlling unit 1 runs predetermined programs to realize functions of the angular velocity obtaining unit and the motion specifying unit.

As a computer readable recording medium to store the program used for performing the above processes can be used portable recording medium such as a flash memory and non-volatile memory other than ROM, a hard-disk drive and CD-ROM. As a communication medium for supplying program-data through a communication circuit can be employed a carrier wave.

Although specific embodiments of the invention have been described in the foregoing detailed description, it will be understood that the invention is not limited to the particular embodiments described herein, but modifications and rearrangements may be made to the disclosed embodiments while remaining within the scope of the invention as defined by the following claims. It is intended to include all such modifications and rearrangements in the following claims and their equivalents.

What is claimed is:

1. A specifying apparatus comprising:
an acceleration obtaining unit which obtains information of an acceleration in a direction of a first axis, wherein the acceleration changes in response to motion of a user using a tool; and
a face specifying unit which specifies a used face of the tool based on the information of an acceleration obtained by the acceleration obtaining unit.

2. The specifying apparatus according to claim 1, further comprising:
an angular velocity obtaining unit which obtains information of a first angular velocity about the first axis, wherein the angular velocity changes in response to the motion of the user using the tool; and
a motion specifying unit which specifies the motion of the user based on the used face of the tool specified by the face specifying unit and the information of a first angular velocity obtained by the angular velocity obtaining unit.

3. The specifying apparatus according to claim 2, wherein
the angular velocity obtaining unit obtains information of a second angular velocity about a second axis, which is different from the first axis, in addition to the information of a first angular velocity about the first axis, and
the motion specifying unit specifies the motion of the user based on the used face of the tool specified by the face specifying unit and the information of a first and a second angular velocities obtained by the angular velocity obtaining unit.

4. A specifying apparatus comprising:
an acceleration obtaining unit which obtains information of an acceleration in a direction of a first axis, wherein the acceleration changes in response to motion of a user;
an angular velocity obtaining unit which obtains information of a first angular velocity about the first axis, wherein the angular velocity changes in response to the motion of the user; and
a motion specifying unit which specifies the motion of the user based on the information of an acceleration obtained by the acceleration obtaining unit and the information of a first angular velocity obtained by the angular velocity obtaining unit.

5. The specifying apparatus according to claim 4, wherein
the angular velocity obtaining unit obtains information of a second angular velocity about a second axis, which is different from the first axis, in addition to the information of a first angular velocity about the first axis, and
the motion specifying unit specifies the motion of the user based on the information of an acceleration obtained by the acceleration obtaining unit and the information of a first and a second angular velocities obtained by the angular velocity obtaining unit.

6. A specifying apparatus comprising:
an acceleration obtaining unit which obtains information of an acceleration in a direction of a first axis, wherein the acceleration changes in response to motion of a user;
an angular velocity obtaining unit which obtains information of a second angular velocity about a second axis, which is different from the first axis, wherein the second angular velocity changes in response to the motion of the user; and
a motion specifying unit which specifies the motion of the user based on the information of an acceleration obtained by the acceleration obtaining unit and the information of a second angular velocity obtained by the angular velocity obtaining unit.

7. The specifying apparatus according to claim 6, wherein
the angular velocity obtaining unit obtains information of a first angular velocity about the first axis, in addition to the information of a second angular velocity about the second axis, and
the motion specifying unit specifies the motion of the user based on the information of an acceleration obtained by the acceleration obtaining unit and the information of a first and a second angular velocities obtained by the angular velocity obtaining unit.

8. The specifying apparatus according to claim 2, wherein
the motion specifying unit specifies a kind of the motion of the user using the tool, on which a body of the present apparatus is mounted.

9. The specifying apparatus according to claim 8, wherein
the motion of the user is a motion of swinging the tool which includes at least one of a forehand swinging motion and a backhand swinging motion.

10. The specifying apparatus according to claim 3, wherein
the motion specifying unit specifies, as the motion of the user, a state of an object which has come in contact with the tool, wherein the body of the present apparatus is mounted on the tool.

11. The specifying apparatus according to claim 10, wherein
the motion of the user includes at least one of the motion of swinging the tool to give the object a slice, the motion of swinging the tool to give the object a spin, and the motion of swinging the tool to give the object a flat.

12. The specifying apparatus according to claim 1, wherein
the first axis extends approximately in parallel with the face of the tool to be used to hit an object, and intersects approximately at right angles with the direction extending from a holding portion of the tool.

13. The specifying apparatus according to claim 12, wherein
the body of the specifying apparatus is fixed on an imaginary axis extending from the holding portion of the tool.

14. The specifying apparatus according to claim 13, wherein
the second axis intersects approximately at right angles with the face of the tool to be used to hit the object.

15. A specifying method in a specifying apparatus, the method comprising:
a step of obtaining information of an acceleration of a tool in a direction of a first axis, wherein the acceleration changes in response to motion of a user using the tool; and
a step of specifying a used face of the tool based on the obtained information of an acceleration.

16. A non-transitory computer-readable storage medium with an executable program stored thereon, wherein the program instructs a computer to function as:
an acceleration obtaining unit for obtaining information of an acceleration of a tool in a direction of a first axis, wherein the acceleration changes in response to motion of a user using the tool; and
a face specifying unit for specifying a used face of the tool based on the information of an acceleration obtained by the acceleration obtaining unit.
